(19) United States
(12) Patent Application Publication
(10) Pub. No.: US 2007/0260212 A1
(43) Pub. Date: Nov. 8, 2007

(54) Ampules for Small Unit Dose Volumes of Drug

(76) Inventor: Robert E. Coifman, Millville, NJ (US)

Correspondence Address: LICATA & TYRRELL P.C., 66 E. MAIN STREET, MARLTON, NJ, 08053, US

(21) Appl. No.: 11/628,774

(22) PCT Filed: Jun. 8, 2005
(86) PCT No.: PCT/US05/20026

§ 371 Date: Dec. 5, 2006

Related U.S. Application Data
(60) Provisional application No. 60/577,872, filed on Jun. 8, 2004.

(51) Int. Cl. A61J 1/06

(52) U.S. Cl. 604/406

(57) ABSTRACT

Ampules are provided for the packaging and storage of drugs intended for nebulizer administration for which physical and/or chemical shelf life stability requires that the drug be stored in other than the diluent in which it will be nebulized, and in a volume or physical state that does not allow accurate dispensing from ordinary ampules.

This patent application claims the benefit of priority from U.S. Provisional Application Ser. No. 60/577,872, filed Jun. 8, 2004, the teachings of which are herein incorporated by reference in their entirety.

### BACKGROUND OF INVENTION

Many drugs, which could be efficiently administered by nebulizer for both topical dosing to the respiratory tract and systemic dosing by inhalation as an alternative to injection, are stable for the short time needed for nebulization in pharmacologically acceptable diluents but require storage for physical and/or chemical shelf life stability as dry powders or in vehicles that cannot be safely nebulized in the volumes needed for effective operation of presently practical nebulizers. Also, many drugs that could be efficiently co-administered in the same bolus of diluent do not have good shelf life stability if stored as ready-to-administer unit doses. Also, with regard to co-administration of two or more drugs in combination, individual patient needs and changing patient needs over time often require different doses of different ingredients. It is impractical to manufacture all possible combinations that might be required or to expect individual patients to stock all combinations that they may need at different times. For economy in manufacturing as well as to minimize administration errors, it is desirable to simplify and standardize to the greatest practical extent the way patients and care-givers administer drugs. For drugs for which the most practical means of administration is by nebulization, it is desirable to have a single technology that is efficient and economical for drugs stored in small volumes of liquids that require dilution for nebulization, and for drugs stored as freeze-dried solids that require dissolution for nebulization. For drugs which may at times be needed in combination and for which the optimal dose of different components of the mix may vary at different times, it is desirable to have a single, simple, user-friendly and efficient way for patients to take whatever dose of whichever components they need when they need it.

Recently developed microporous membrane nebulizers offer greater portability and greater control, precision and uniformity of aerosol particle size than previously available jet nebulizers. They also have different parameters for optimal drug packaging. Jet nebulizers have a functional dead space (volume of fill remaining in the device when effective nebulization stops) in the range of 0.5 to 1 ml, mandating dilution of medication fill volumes to approximately 2.5 ml or more, or the “washing through” of remaining medication by additional diluent, for effective, reproducible dosing. In contrast, microporous membrane nebulizers have zero functional dead space. For maximum user convenience and speed of dosing, medications intended for nebulization with microporous membrane devices should be dosed in volumes that would barely fill the functional dead space and not nebulize at all with the older generation of jet nebulizers.

New dosing technologies make it possible to achieve reproducible systemic dosing of many systemically acting drugs by inhalation, as a patient-preferred alternative to repeated injections. Many new products of genetic and molecular engineering fall into this class. To achieve acceptable shelf-life stability, many of these drugs require either storage in the freeze-dried state for reconstitution immediately prior to administration, or storage in small volumes of liquid vehicle, which are not themselves pharmaceutically acceptable for nebulizer administration but which can be made pharmaceutically acceptable by mixing with larger volumes of appropriate diluents, immediately prior to administration. In some circumstances, these medications may be more effective or better tolerated by patients if co-administered with other drugs. Optimal prescribing in many such cases requires sufficient dose individualization and/or variation over time to render the manufacture of all commonly used fixed dose combinations impractical.

There is thus a need for a flexible yet standardizable packaging and delivery system to meet these medication needs and fully exploit their therapeutic potential.

A number of two chamber ampule and vial systems have been developed to address such needs. One such system is described in U.S. Pat. No. 6,247,617. Limitations of this system include the following. For drugs that require non-physiologic storage conditions for shelf-life stability, it is desirable to store unit doses at the highest possible concentration in the smallest possible volumes of non-physiologic vehicle, to minimize the amount of non-physiologic material administered on nebulization. For drug volumes of less than approximately 50 microliters, a significant and variable fraction of the packaged drug dose may be left on the walls of a drug chamber like that of U.S. Pat. No. 6,247,617 that is not rinsed or “washed out” into the full nebulizer mix. Thus, dosing can become irregular and unpredictable. Further, while ampule and vial systems have been developed in which there is “washing out” of the entire drug storage chamber with the resulting nebulizer mix, such systems do not address stability and shelf-life issues and dose variation issues. In addition, such systems have the drawbacks of relatively cumbersome and costly filling processes for the separate chambers, and the requirement that the first chamber to be filled must then tolerate whatever conditions are created in the process by which the second chamber is filled.

### SUMMARY OF THE INVENTION

The present invention provides ampule designs suitable for the packaging of small volumes of drug solution or suspension or solid phase drugs for dissolution. The ampule comprises an integrated mixing chamber and an aperture designed to facilitate accurate pouring in of diluent or diluent already mixed with other drugs. The same aperture, in some embodiments modified by cutting off a portion to create a narrow outflow slit, is configured to facilitate accurate pouring out of the drug-diluent mix after mixing, into either the intake reservoir of a nebulization device or into another ampule of the present invention for mixing with another drug. In one embodiment, the ampule comprises an upper cone that flips down into a lower cone that serves as a funnel for pouring in of diluent into the integrated mixing chamber and flips up to create a narrow exit orifice for pouring out of drug mixed with diluent from the integrated mixing chamber. In other embodiments, an upper cone serves as a sterile closure during storage and a separate pouring spout may be provided. In different embodiments the ampule is designed to accommodate liquid drug concentrate volumes as small as 2 to 10 microliters or one or more small, breakable inner ampules containing either dry drug in a solid phase or a liquid dosage form for which ampule adherence properties are such that without the separate inner ampule there would be a risk of drug loss by adherence to the walls of the outer ampule. The ampule is designed to be scalable to accommodate any reasonable target fill volume or mixing volume for unit dose nebulizer administration.

### BRIEF DESCRIPTION OF THE FIGURES

FIG. 1A provides a top view of a circular-shaped ampule of the present invention with a cylindrical mixing chamber.

FIG. 1B provides a cross-sectional side view of the same circular-shaped ampule depicted in FIG. 1A.

FIG. 2A provides a top view of a polygonal-shaped ampule of the present invention.

FIG. 2B provides a cross-sectional side view of the same polygonal-shaped ampule depicted in FIG. 2A.

FIGS. 3A and 3B provide cross-sectional side views of an embodiment of the circular-cross-section ampule illustrated in FIG. 1, further comprising a movable upper cone. The upper cone is in a down position for pouring in FIG. 3A and in an up position for pouring out in FIG. 3B.

FIG. 4 provides a cross-sectional side view of the upper part and fill parts of two ampules of the design shown in FIGS. 1 and 3, ready to be joined together after filling.

FIG. 5A provides a cross-sectional side view of an embodiment of an ampule having a narrow tear line molded into the ampule fill part just above the lower cone and just below the join line. In this embodiment, the ampule further comprises large, firm twist tabs molded into both the upper part and the fill part. In this embodiment, the ampule is opened by twisting the upper and lower twist tabs in opposite directions to tear off the top of the ampule along the thin tear line, between the cones.

FIG. 5B shows a cross-sectional top view of the ampule depicted in FIG. 5A.

FIG. 6A provides a cross-sectional side view of an embodiment in which a smaller, brittle, breakable ampule containing a unit dose of medication was placed in the fill part of the ampule at the time of manufacture, before the top and fill parts of the ampule were joined together. In this figure the drug is shown as a particulate solid, which could be either a powder or crystals produced by freeze-drying. The drug in this inner ampule could also be a liquid. The brittle inner ampule is broken open after addition of diluent, by pinching it through the tougher more flexible walls of the mixing chamber. A rigid base on this embodiment could interfere with the pinching movement by which the brittle inner ampule is broken. This embodiment is therefore shown without a base and is held upright instead by placement in a supporting rack, also shown.

FIG. 6B provides a cross-sectional top view of the ampule of FIG. 6A when placed in the rack.

FIG. 7 provides a cross-sectional side view of an ampule containing a smaller, breakable ampule of unmixed, undiluted and/or undissolved drug, within the mixing chamber of the ampule. In this embodiment the smaller breakable ampule is anchored to the bottom of the mixing chamber to keep fragments of the smaller ampule from pouring out of the larger ampule once the drug has been mixed with diluent.

FIG. 8 provides a cross-sectional side view of another embodiment of an ampule, also containing a small inner ampule for drug as either a dry solid or concentrated in a liquid shelf-life storage vehicle, within the mixing chamber of the outer ampule. In this embodiment the inner ampule is also anchored to the bottom of the mixing chamber to retain fragments when the ampule is emptied. In this embodiment, however, the inner ampule is soft rather than brittle and is torn open by pulling (to stretch out) a wire that is coiled within the wall of the inner ampule with its other end anchored to bottom of the mixing chamber.

FIG. 9 provides a cross-sectional side view of the upper part and fill parts of two ampules of the embodiment shown in FIG. 5, being joined together after filling.

FIGS. 10A and 10B provide cross-sectional top and side views, respectively, of an embodiment of an ampule of the present invention wherein the top of the mixing chamber is narrower than its body and bottom. In this embodiment, as depicted in FIG. 10A, the twist tabs and upper and lower cones are thicker, and thus more rigid, than the walls of the mixing chamber to transfer the torque of twisting to tear open the thin tear line between the cones. As shown in FIG. 10B, the lower twist tabs are attached to the lower cone and the narrower top of the mixing chamber but separate from the mixing chamber as they extend downward, parallel to the body of the mixing chamber, to form legs on either side of the mixing chamber. The inner and outer edges of one leg formed by the lower twist tabs are shown by arrows in FIG. 10B. Further depicted in FIG. 10B is a brittle inner ampule containing a liquid medicament which is covered by an adherent flexible mesh to keep fragments of the inner ampule together after it is broken by pinching through the flexible walls of the mixing chamber. In addition, FIG. 10B shows a baffle in the form of a row of teeth extending across the inside of the narrower top of the mixing chamber which keeps the broken inner ampule from being poured out with the medication after the medication is mixed with diluent.

FIG. 11 provides a cross-sectional side view of two parts of the ampule embodiment depicted in FIGS. 10A and 10B, after molding of each part but prior to joining of the parts. This Figure shows several fill options labeled as: (a) insertion of a measured volume of drug-containing liquid; (b) insertion of a brittle inner ampule covered with an adherent, flexible mesh, illustrated herein filled with drug in the form of microcrystals or powder; (c) attachment of a brittle inner ampule similar to (b) but containing a drop of liquid medication and further comprising a tether to anchor the inner ampule to the base of the mixing chamber; and (d) attachment of a soft plastic inner ampule, also with a tether to anchor it to the bottom of the mixing chamber and with a tear cord or tear wire molded into its wall that will tear the inner ampule apart, releasing its contents into the surrounding diluent, if the tear cord or wire is pulled after diluent is added. The top of the tear cord or tear wire is tethered to the top of the ampule, which, after opening and pouring in diluent, serves as a handle with which the tear cord or wire can be pulled to tear apart the inner ampule.

### DETAILED DESCRIPTION OF THE INVENTION

The present invention provides single, disposable ampules for storage and dilution of small volumes of drug in either liquid vehicle or in solid phase for suspension or dissolution in diluent at the time of nebulization.

By small liquid volume, as used herein, it is meant a liquid volume sufficiently small that its physical and chemical properties will not alter the nebulization characteristics of the diluent, and that the mass of any non-physiologic constituents will be below the threshold of toxicity. Such volumes will generally be in the range of 2 to 100 μl.

By small solid volume, as used herein, it is meant a volume of solid phase drug small enough for easy and efficient dissolution or suspension in a volume of diluent sufficient for efficient administration in the device intended for nebulization, without adversely affecting the nebulization properties of the resulting solution or suspension. With presently available nebulization devices, practical upper limits for a small solid volume for most clinical applications will be of the order of magnitude of 1 mg. However, as understood by those skilled in the art, the practical upper limit for nebulization does not determine the effective dose of a drug. Instead, the relationship between the desired treatment dose and the practical upper dose limit for this technique will determine the appropriateness of this delivery system for each drug. As the practical upper limit is also limited by the number of minutes one wishes to ask a user to spend inhaling each dose, if a particular treatment is critical and there are no practical alternatives, it may become practical to use larger volumes of liquid or solid drugs requiring larger volumes of diluent and correspondingly longer nebulization times.

The practical ability to increase dose by increasing nebulized volume and treatment time may not apply to drugs stored for shelf life stability in non-physiologic liquid storage vehicles, as increasing dose of these formulations will result in increased dose of excipients along with increased doses of drug, raising issues of possible excipient toxicity.

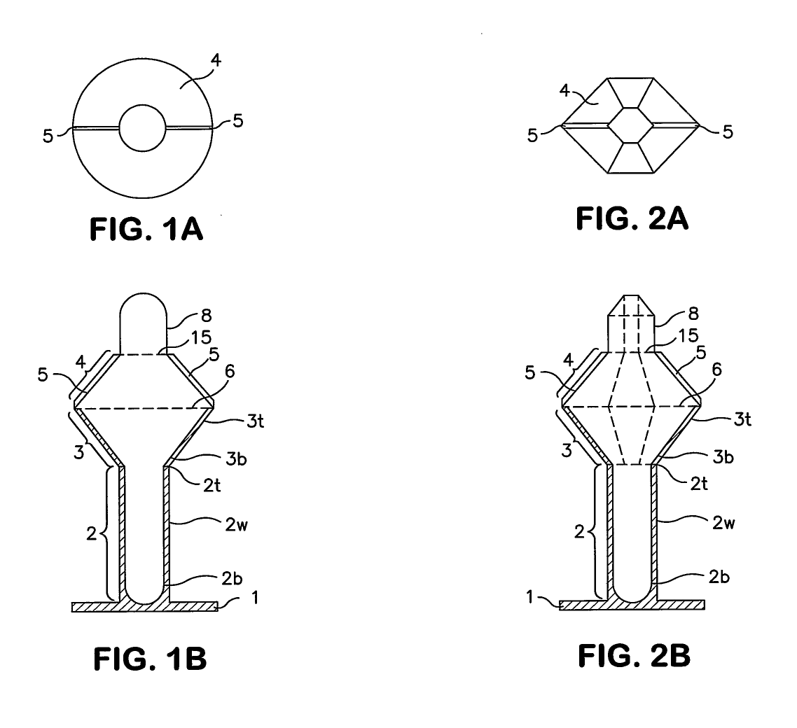

Various ampule designs of the present invention are exemplified by FIGS. 1 through 11.

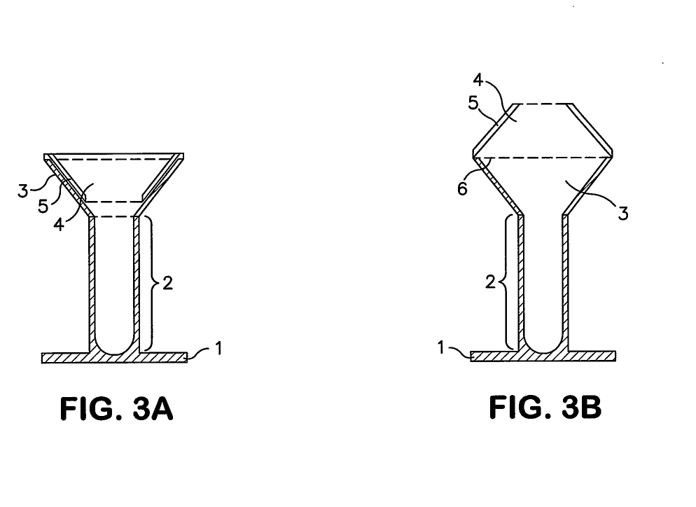

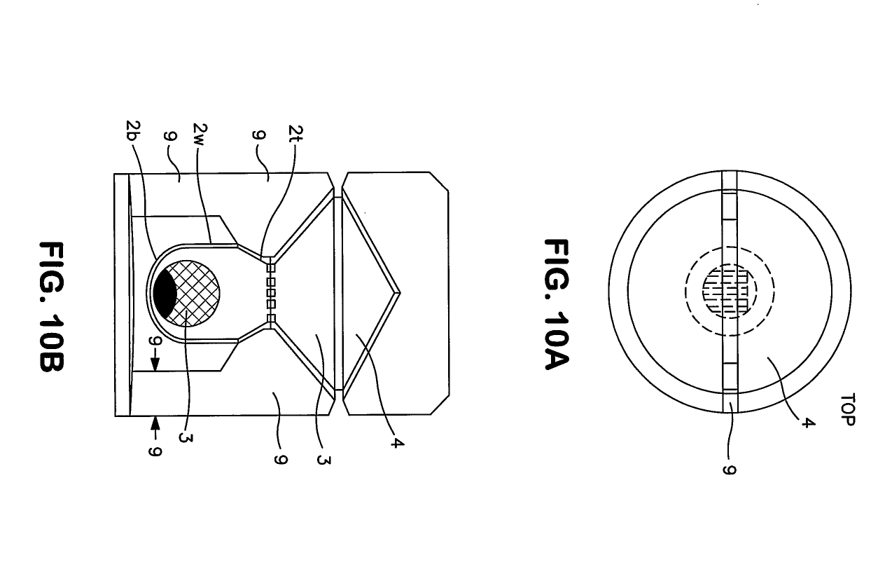

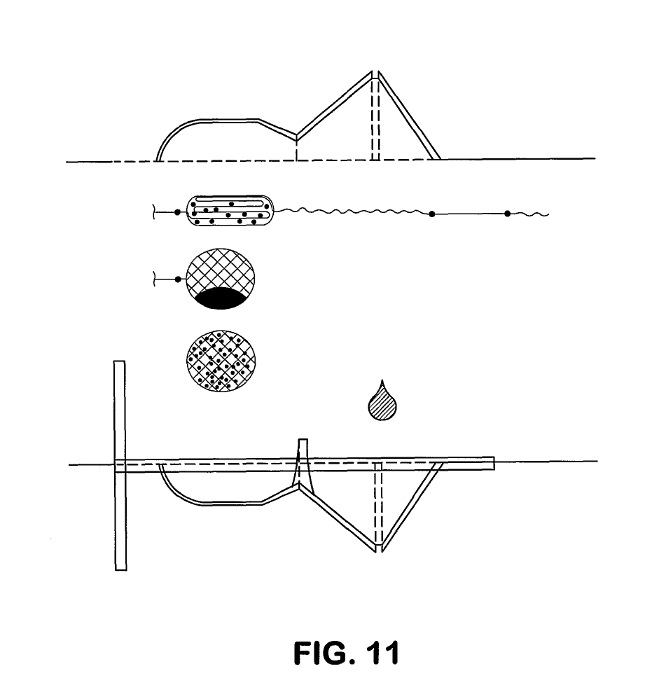

As shown in these figures, all ampule designs of the present invention comprise a lower chamber, referred to as the medication mixing chamber 2 with side walls 2w, an open top 2t, and a sealed bottom 2b. As shown by FIGS. 1A and 1B and FIGS. 2A and 2B, ampules of the present invention may have various shapes including, but not limited to, circular, oval or polygonal. The medication mixing chambers will generally but not necessarily have rounded bottoms and their shapes above the bottoms may be cylindrical (see FIG. 1), polygonal (see FIG. 2), or shaped similar to a jar (see FIGS. 10 and 11) wherein the top 2t is narrower than the body between the side walls 2w.

All ampules of the present invention further comprise an intake aperture designed to facilitate the precise and accurate pouring in of diluents and an outflow aperture designed to facilitate the precise and accurate pouring out of the diluent-drug mix after mixing. The intake and exit apertures may or may not be one and the same. Intake apertures will generally but not necessarily have the shape of a cone or polygonal cross-section pyramid. The outflow aperture in different embodiments may be the same as the intake aperture or may be a pouring spout incorporated in an intake cone, the narrow opening in an upper cone, or a slit cut out of an upper cone.

In the illustrated embodiments the intake aperture comprises a lower cone or pyramid 3 positioned at the top 2t of the medication mixing chamber 2. The lower cone 3 comprises a narrower bottom 3b contiguous with the top 2t of the medication mixing chamber 2 and a wider open top 3t.

All ampules of the present invention further comprise an upper cone or pyramid 4, either closed at its own apex or topped by a closed cap 8. The upper cone or pyramid 4 is attached at its lower and widest circumference to the upper and widest circumference of the lower cone or pyramid 3.

In various embodiments of this invention, the drug packaged in the ampule is delivered to the medication mixing chamber prior to opening the ampule (to add diluent which may or may not already contain other drugs) either by tapping the bottom of the unopened ampule against a hard surface to tap down any drug adherent to the upper parts of the ampule, by positioning the ampule so that a brittle inner drug-containing ampule falls to the bottom of the mixing chamber, or packaging the drug in an inner ampule 13 that is already anchored to the bottom of the medication mixing chamber.

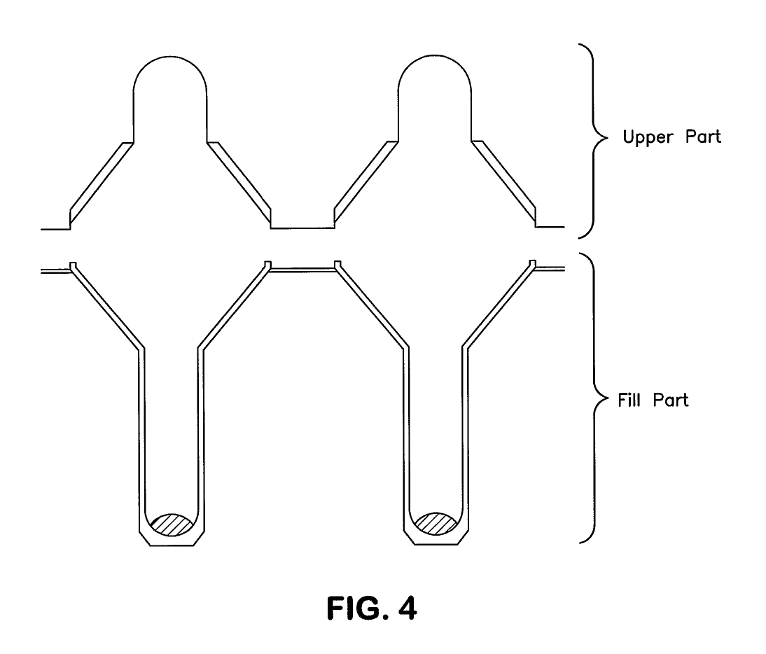

In embodiments of the ampule of the present invention depicted in FIGS. 1 through 4, the upper cone 4 with cap 8 is joined to the lower cone 3 during manufacturing via a horizontal join line 6. In the embodiments of FIGS. 1 and 2, the ampule is opened by cutting off of the cap from the ampule. In some embodiments, as depicted in FIGS. 1 and 2, a horizontal cut line 15 between the cap 8 and the upper cone 4 is provided for guidance in removing the cap from the rest of the ampule with, for example, a cutting means such as scissors or a sharp blade or mini-blade provided with the ampule or via tearing of the cap from the upper cone once a small cut has been made along the cut line 15. As shown in FIG. 3, in this ampule embodiment of FIG. 1 through 4, upon removal of cap 8, the upper cone 4 is made sufficiently flexible and sized to flip or fold down into the lower cone for pouring in of diluents. Thus, in these embodiments, the upper cone will 4 usually be molded of the same plastic as the fill part of the ampule, consisting of the lower cone 3 and the mixing chamber 2, but walls that are sufficiently thin and flexible to allow the upper cone 4 to be flipped inside out into the lower cone 3 when the two thicker, more rigid vanes 5 at opposite sides of the upper cone 4 are flipped down into the lower cone 3. The upper cone may be flipped inside out into the lower cone by hand through a sterile outer package or an implement may be provided for this purpose. In this embodiment, after diluent is added, the upper cone is flipped back up by pulling upward on the vanes to help prevent spilling when the contents of the ampule are mixed, usually by gentle swirling. After mixing, the contents of the ampule may be poured into the nebulizer or a next ampule if the contents are to be mixed with another drug, by either inverting the ampule or by cutting off one of the vanes 5 to create a pouring spout, using the same cutting means previously used to cut off the top of the ampule.

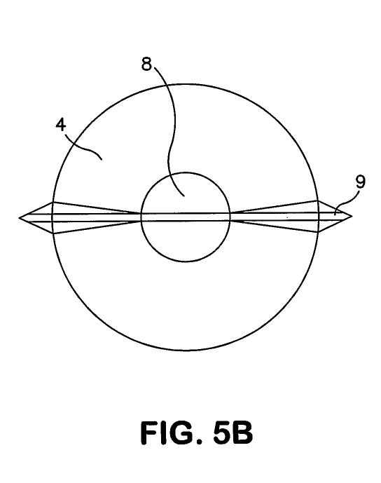

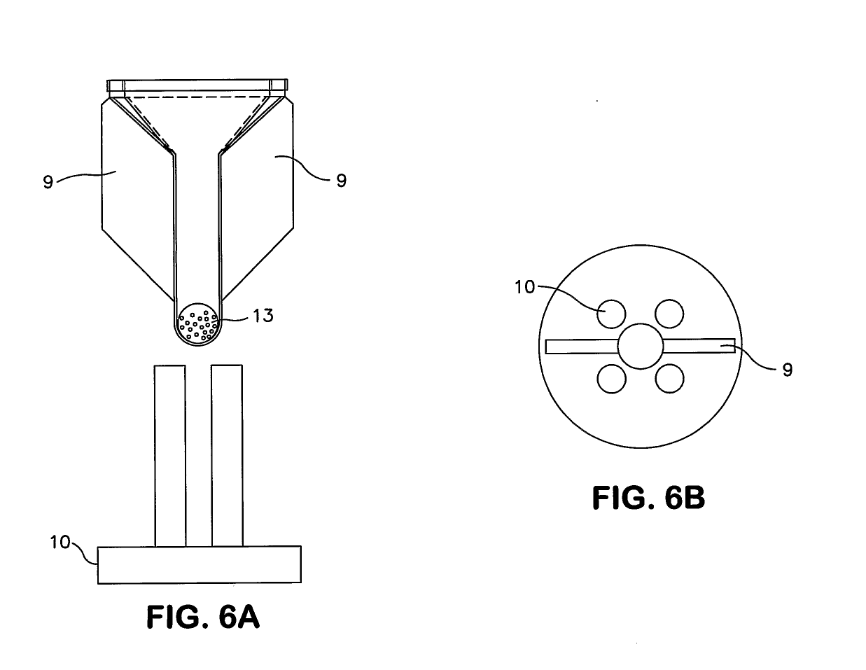

Alternatively, in embodiments of the ampule of the present invention depicted in FIGS. 5 through 11, the ampule further comprises a horizontal tear line 7 between the upper and lower cones. As shown in FIG. 5, in embodiments with a horizontal join line 6, the horizontal tear line is parallel and positioned just above the join line 6. In embodiments such as depicted in FIGS. 6 through 8 wherein the manufacturing join line 6 extends vertically, the tear line extends perpendicularly with respect to the join line and horizontally between the upper and lower cones. In the embodiments depicted in FIGS. 5 through 11, the ampule is opened by tearing, generally by twisting of the ampule above and below this line in opposite directions. In these embodiments, the cones and mixing chamber are of a tougher construction as compared to the thin tear line. Further, as shown in FIGS. 5, 9, 10 and 11, these embodiments may further comprise relatively large, tough and rigid twist tabs 9 attached to the sides of the ampule above and below the tear line, so that twisting in opposite directions will tear the ampule open along the tear line. Depending on the rigidity of the rest of the ampule and the thickness and tear resistance of the tear line, it may be desirable to provide a small, sterilely sheathed blade to create an initial cut along a small portion of the tear line before twisting. As shown in FIG. 10 the lower twist tab may serve a dual functional purpose in stabilizing the ampule by forming legs parallel, but separate to the body of the mixing chamber.

Each ampule embodiment further comprises either a base 1 or rack 10 to support the ampule in an upright position. For ampule designs in which the bottom of the medication mixing chamber 2 must be sufficiently tough and flexible to enable pinching the outer ampule to break open a brittle inner ampule and shatter it sufficiently to allow effective mixing of its contents with the surrounding diluent, a base cannot be directly attached to the bottom of the ampule as such an attachment would reduce the flexibility needed for pinching. These embodiments provide for either a rack from which the ampule can be removed to pinch the medication mixing chamber and break the inner ampule (see FIG. 6), or for attachment of a base to legs extending down from the lower twist tabs, with placement of the legs and base sufficiently far from the body and base of the medication mixing chamber that they will not impair its ability to deform when pinched (see FIG. 10). Small, easily cleaned racks are envisioned for such ampules without bases.

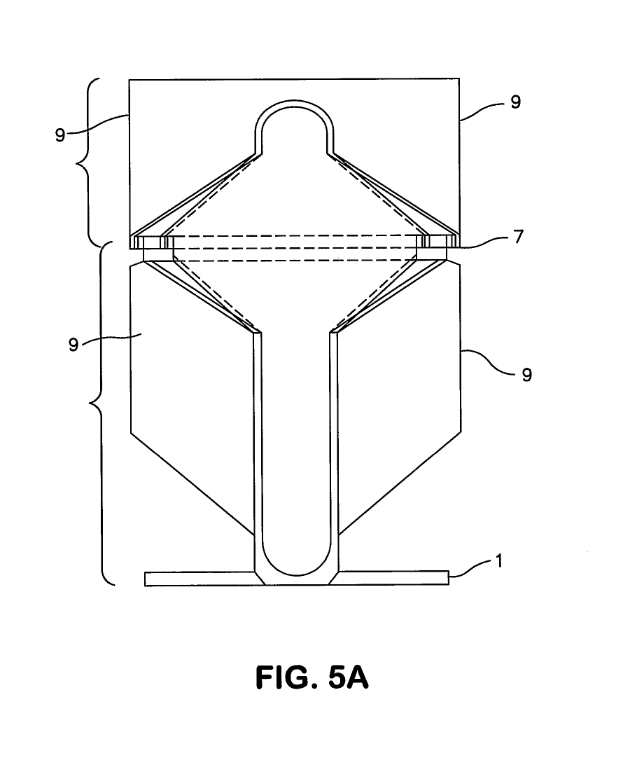

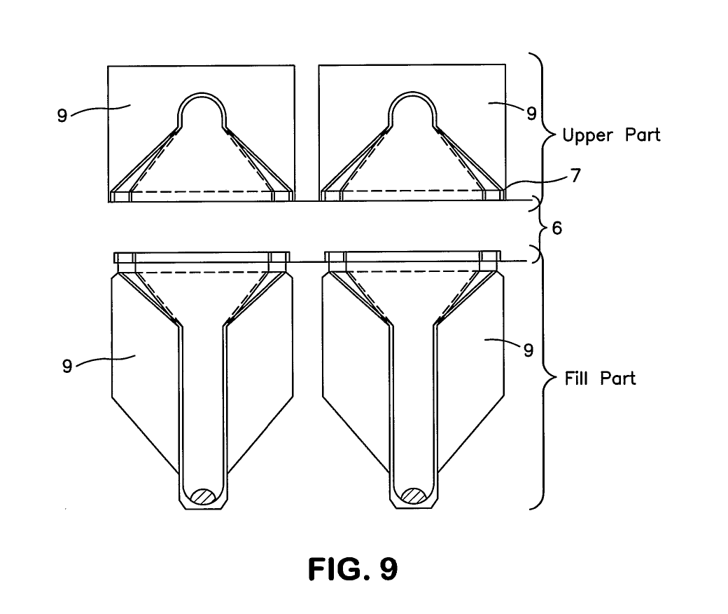

For manufacturing of ampule designs of FIG. 1 through 6 and FIG. 9, it will generally be most efficient to mold a first sheet of mixing chambers 2 attached to lower cones 3 as one unit and a second sheet of upper cones 4 and caps 8 as a separate unit. See FIG. 4. For all embodiments for which the lower cone and mixing chamber are molded as one piece and the upper cone and top are molded as a second piece, the part consisting of the lower cone and mixing chamber is referred to herein as the “fill part” of the ampule and the part consisting of the upper cone and top is referred to herein as the “upper part” of the ampule. The fill parts of these ampules are generally filled while they remain in the outer parts of the molds in which they are made, after which a sheet of matching upper parts, generally still in the outer part of the mold in which they were made, is lowered onto the sheet of filled fill parts. If freeze-drying of content is required, it can be done with the filled fill parts, in the outer part of the molds in which they were made, before they are covered with upper parts and sealed. Upper parts positioned over filled fill parts are shown for different embodiments in this class in FIGS. 4 and 9. When the sheet of upper parts has been lowered into place over the sheet of filled fill parts, the ampules are sealed along the join line between the upper and lower cones, generally by heat. If the ampules are molded in sheets, they will generally be cut out of their sheets in the course of the same process that seals the ampules along the join line. These ampule designs will generally be molded in the position shown in FIGS. 4 and 9, as arrays of from 4 to as many as 400 ampules in large sheets. They can be filled, sealed, lifted out of their lower molds and bases attached to those embodiments that have bases, before the array of ampules is separated from the outer part of the mold in which the upper parts were made. Ampules requiring storage in a sterile outer wrapper will generally be placed in such wrappers at this stage of packaging.

All embodiments of the invention in which an inner ampule is tethered to the bottom of the main ampule of the invention are molded in a horizontal position, so that the tether can be anchored to the bottom when the two pieces of the main ampule are sealed together after filling. In these embodiments the join line extends around the ampule from top to bottom in a plane perpendicular to the plane of the tear line, which runs circumferentially around the ampule between the cones.

If storage stability requires a specific atmosphere, such as dry nitrogen, the plastic used for the ampule must be impermeable to both the gases one wants to keep in and those one wants to keep out, and the ampules must be sealed in the required atmosphere.

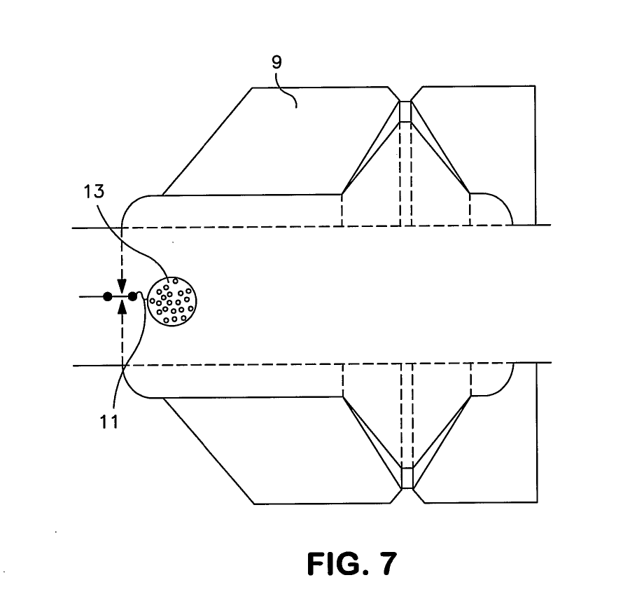

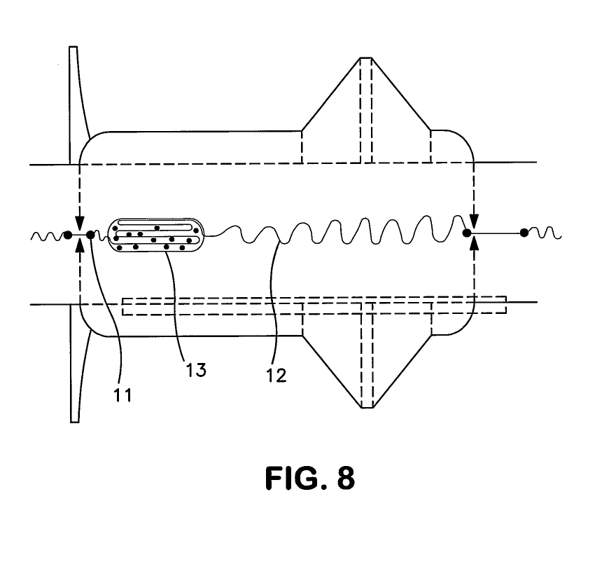

Embodiments as depicted in FIGS. 7 and 8 in which a separate inner ampule is tethered to the bottom of the outer ampule and embodiments as depicted in FIGS. 10 and 11 in which the mixing chamber has the shape of a jar with a neck that is narrower than its body, will generally be molded on their sides, with a join line that extends vertically around the ampule from top to bottom instead of horizontally around the cross-section between the upper and lower cones. This allows the already filled inner ampule to be tethered to the bottom via a fixing means 11 (and for the embodiment with a tearing wire 12 also to the top as depicted in FIG. 8) of the outer ampule as it is sealed. For the embodiments of FIGS. 8 and 11, a base 1 can be molded onto the ampule at the same time that the rest of the ampule is molded.

For manufacturing and filling operations in which filled and sealed ampules are transferred or transported while still in position in the outer part of the molds in which the upper parts were made, it may be most practical to flip FIGS. 8 and 11 upside down, use the half of the mixing chamber and inflow/outflow apertures without the tear tabs and base as the fill part, and the half of the mixing chamber and inflow/outflow apertures that is molded attached to the tear tabs and base as the upper part.

Ampules of the present invention may contain a single ingredient or fixed dose combination of ingredients, either freeze-dried in the mixing chamber or dissolved or suspended in volumes of liquid vehicle as small as 2 to 10 microliters. Drug may also be stored in a separate inner ampule, to be broken after diluent is added to the outer ampule, when there is a risk of loss by adherence to surfaces of the ampule in the absence of this precaution. This may occur for drugs in the form of fine powders and for drugs in small volumes of liquid vehicles with surface tension and boundary layer properties that favor the unrecognized adherence of small volumes of drug powder or drug in vehicle to the inside of the ampule, in the absence of a separate, inner ampule. Such small inner vials may be brittle so that the vial is broken by pinching the flexible sides of the outer ampule over the brittle inner ampule. In this embodiment, the brittle inner vial preferably further comprises a flexible outer mesh coating to keep the broken pieces together and prevent their being poured out with the drug mix when the ampule is emptied. Broken inner ampule pieces can also be prevented from pouring out of the drug mix via a baffle 15 such as depicted in FIG. 10. Preferably the baffle comprises a row of teeth extending across the inner open top of the medicine mixing chamber which prevent the broken inner ampule pieces from pouring out with the drug mix. In other embodiments, the inner ampule is soft rather than brittle and is torn open by pulling (to stretch out) a wire that is coiled within the wall of the inner ampule.

Cleanliness rather than sterility is all that is needed for this step for the overwhelming majority of patients taking inhaled medications, as only liquids need to be kept sterile up to the time of nebulization and hard, dry surfaces including those of the nebulizers used to administer these medications need only be kept clean.

Drug formulations packaged directly in the medication mixing chamber of the ampules of this invention will generally be freeze-dried drugs requiring mixing and dissolution for nebulization, or small volumes of drug in solution or suspension in a liquid vehicle that may or may not be pharmaceutically acceptable for nebulization as it is, but that can be made pharmaceutically acceptable for nebulization by mixing with a larger volume of an appropriately formulated diluent. The diluent may already contain other drugs at the time that it is added. If there is a risk of loss of the intended drug content by unrecognized or hard-to-control adherence to the inside of the ampule, which will most commonly be the case for drugs in the form of fine powders, the drug may be packaged in a separate inner ampule, for which several embodiments have been shown (FIGS. 6, 7, 8, 10 and 11).

It is anticipated that the drug packaged in the ampule will generally be mixed with the diluent or mix of diluent and other drugs that has been poured into the mixing chamber by gently swirling the ampule. It is possible that certain combinations of drug and diluent may require alternate mixing procedures.

Various means for filling the ampules of the present invention are depicted in FIG. 11. As shown therein, the ampules can be filled by inserting a measured volume of drug-containing liquid, represented in this figure by a drop above the lower half of the cone, prior to joining together the two halves of the ampule. This drop may comprise either a liquid which remains liquid in the ampule after sealing or a liquid which is evaporated or frozen and then sublimed to leave solid phase drug in the outer ampule before the two halves are joined. Alternatively, a brittle inner ampule covered with an adherent, flexible mesh, filled with drug in the form of microcrystals or powder or a drop of liquid medication can be inserted and in some embodiments attached or tethered to the bottom of the ampule. In yet another embodiment, drug is packaged in a soft plastic inner ampule, also with a tether to anchor it to the bottom of the mixing chamber and with a tear cord or tear wire molded into its wall that will tear the inner ampule apart, releasing its contents into the surrounding diluent, when the tear cord or wire is pulled after diluent is added. In this embodiment, the top of the tear cord or tear wire is tethered to the top of the ampule, which, after opening and pouring in diluent, serves as a handle with which the tear cord or wire can be pulled to tear apart the inner ampule.

When the fill of the embodiment of the ampule illustrated in FIGS. 10 and 11 is a soft inner ampule with a cord or wire embedded in its wall, to tear it open when pulled at both ends, the following two additional embodiments, described herein but not illustrated, will give greater stability to the lower anchor than tethering it to the thin, flexible, relatively movable wall of a mixing chamber designed to be easily deformed by pinching. One of these embodiments is to extend the tearing cord or wire down, across the open space around the body of the mixing chamber in FIG. 10 and further tether it to the base of the ampule. The other is to extend the tether down below the bottom of the mixing chamber and fill in the empty space provided around the base of the mixing chamber in FIG. 10, possibly also increasing the thickness and rigidity of the wall of the mixing chamber. In this embodiment the lower twist tabs remain in contact with the sides of the medication mixing chamber all the way down to the bottom 2b of the mixing chamber, and the base of the ampule may directly abut the bottom of the mixing chamber. In this embodiment it is most practical to mold half of the base of the ampule attached to each half of the body of the ampule, unlike the embodiment shown in FIG. 11 in which there is empty space around the body of the mixing chamber and the entire base is molded to the half of the body of the ampule to which the twist tabs are molded.

Further, it is possible using the ampules of the present invention to package two or more drugs separately via means of sealed inner ampules in the same ampule, to be mixed within the same ampule upon addition of diluent. One drug may be placed directly in the outer ampule in a small volume of liquid, and one or more drugs may be packaged in inner ampules of the types previously described, which are placed or tethered in the outer ampule prior to sealing.

What is claimed is:

1. An ampule for storage and accurate delivery of quantities of a solid or liquid formulation of a drug for nebulizer administration that is formulated in a small volume comprising:
(a) a medication mixing chamber with an open top and a sealed bottom and a body with an intake geometry and volume which allows diluent to be precisely and accurately poured into the ampule and mixed with its contents therein; and
(b) an outflow aperture contiguous with the top of the medication mixing chamber with a geometry which permits precise and accurate pouring out contents of the medication mixing chamber after mixing with diluent into a nebulizer or second drug containing ampule.

2. The ampule of claim 1 wherein the medicine mixing chamber is cylindrical or polygonal in shape with a sealed bottom and open top and the outflow aperture comprises:
a lower cone with a narrower bottom contiguous with the top of the medication mixing chamber and a wider open top;
an upper cone with a wider bottom and narrower top attached to the wider open top of the lower cone; and
a cap which seals the narrower open top of the upper cone.

3. The ampule of claim 2 wherein the cap is removable and upon removal the upper cone is capable of flipping down into the lower cone for pouring in of liquids and flipping up to create a narrow exit orifice for pouring out of contents in the medicine mixing chamber.

4. The ampule of claim 3 wherein the upper cone further comprises a vane attached to the upper cone to facilitate movement of the upper cone and stabilize the upper cone.

5. The ampule of claim 2 further comprising a horizontal tear line at or near a position at which the upper and lower cones attach so that the ampule can be opened by tearing of the upper cone from the lower cone and medicine mixing chamber.

6. The ampule of claim 5 further comprising twist tabs attached to the ampule above and below the horizontal tear line which when twisted in opposite directions facilitate tearing open of the ampule.

7. The ampule of claim 2 wherein the medicine mixing chamber is sized to hold 2 to 100 μl of drug solution or suspension or solid phase drug.

8. The ampule of claim 2 further comprising an inner drug containing ampule in the medicine mixing chamber.

9. The ampule of claim 8 wherein the sealed bottom of the medicine mixing chamber is sufficiently flexible to permit pinching to break open the inner drug containing ampule.

10. The ampule of claim 8 wherein the inner drug containing ampule is fixed to the bottom of the mixing chamber.

11. The ampule of claim 10 further comprising a wire extending from the inner ampule to the cap which when pulled tears open the inner drug containing ampule releasing drug into the medicine mixing chamber.

12. The ampule of claim 2 further comprising a base or rack to hold the ampule in an upright position.

13. The ampule of claim 1 wherein the top of the medication mixing chamber is narrower than the body and sealed bottom of the medication mixing chamber.

14. The ampule of claim 1 in which a small volume of drug in solution is freeze-dried before the ampule is sealed.

15. The ampule of claim 1 in which drug is inserted already sealed in a separate inner ampule, designed to be broken or torn open so that its contents may be mixed with diluent in the mixing chamber.

16. The ampule of claim 15 further comprising a baffle extending across the top of the medication mixing chamber which prevents any broken pieces of the separate inner ampule from pouring out with the mix of drug and diluent.

17. The ampule of claim 15 wherein the separate, inner ampule is tethered to the bottom of the medication mixing chamber.

18. The ampule of claim 17 wherein the separate, inner ampule further comprises a cord or wire positioned within its wall such that pulling said cord or wire will tear open the inner ampule.

19. The ampule of claim 1 containing two or more drugs stored separately by means of sealed inner ampules, until the time of mixing with diluent.
